(19) United States
(12) Patent Application Publication
(10) Pub. No.: US 2005/0052219 A1
(43) Pub. Date: Mar. 10, 2005

(54) Integrated circuit transistor body bias regulation circuit and method for low voltage applications

(76) Inventors: Douglas Blaine Butler, Colorado Springs, CO (US); Kim C. Hardee, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/918,954

(22) Filed: Aug. 16, 2004

Related U.S. Application Data
(60) Provisional application No. 60/500,126, filed on Sep. 4, 2003.

(51) Int. Cl. G05F 1/10

(52) U.S. Cl. 327/534; 327/537

(57) ABSTRACT

An integrated circuit transistor body bias regulation circuit and method of especial applicability with respect to low voltage applications wherein the threshold voltage (Vₜ) of certain transistors is lowered at low power supply voltage (VCC) levels, low temperature and/or high Vₜ process conditions to assure adequate transistor drive but may also be raised at high VCC levels, high temperature and/or low Vₜ process conditions to reduce leakage current. In this manner, circuit speed that is closer to constant (versus VCC, temperature and process variation) is thereby achieved.

### CROSS REFERENCE TO RELATED PATENT APPLICATIONS

The present invention claims priority from U.S. Provisional Patent Application Ser. No. 60/500,126 for: “0.6V 205 MHz 19.5 nsec TRC 16 Mb Embedded DRAM” filed Sep. 4, 2003, the disclosure of which is herein specifically incorporated by this reference in its entirety.

### BACKGROUND OF THE INVENTION

The present invention relates, in general, to the field of integrated circuit (IC) devices. More particularly, the present invention relates to an integrated circuit transistor body bias regulation circuit and method of especial applicability with respect to low voltage applications.

Low power embedded DRAM is currently among the best memory solutions for mobile personal consumer applications requiring high speed graphics and long battery life. The 16 Mb embedded DRAM macro disclosed in the aforementioned provisional patent application, incorporated by reference herein, achieves low power operation by reducing the power supply voltage further than those disclosed in previous reports while still providing high bandwidth with 128 inputs/outputs (I/Os) and simultaneous read/write capability.

Low voltage operation requires reducing transistor threshold voltages. Unfortunately, this results in increased transistor “off” current and, therefore, higher standby power. Also, at very low operational voltages, circuit speed can degrade as threshold voltage (Vₜ) increases due to process and temperature variations. Several recent efforts (see, for example, S. Tomishima et al., “A 1.0V 230 MHz Column-Access Embedded DRAM Macro for Portable MPEG Applications”, ISSCC pp. 384-385, February 2001; J. Barth et al., “A 300 MHz Multi-Banked eDRAM Macro Featuring GND Sense, Bit-Line Twisting and Direct Reference Cell Write”, ISSCC, pp. 156-157, February 2002; and J. Sim et al., “A 1.0V 256 Mb SDRAM with Offset-Compensated Direct Sensing and Charge-Recycled Precharge Schemes”, ISSCC, pp. 310-311, February 2003) have indicated the achievement of 1.0V operation. Still other reports have apparently demonstrated the use of body bias regulation techniques in logic circuits (see, for example, M. Miyazaki et al., “A 1.2-GIPS/W Microprocessor Using Speed-Adaptive Threshold-Voltage CMOS with Forward Bias”, JSSC, Vol. 37, pp. 210-217, February 2002 and J. Tschanz et al., “Adaptive Body Bias for Reducing Impacts of Die-to-Die and Within-Die Parameter Variations on Microprocessor Frequency and Leakage”, JSSC, Vol. 37, pp. 1396-1402, November 2002) to minimize variations in circuit speed. In these latter reports, the body bias regulators employed functioned by monitoring the speed of reference circuits to set the body bias voltages.

### SUMMARY OF THE INVENTION

Disclosed herein is an integrated circuit transistor body bias regulation circuit and method of especial utility with respect to low voltage applications. The disclosed method of regulating body bias minimizes circuit speed variation by making the Vₜ of the transistors of a circuit a function of the supply voltage and substantially independent of process and temperature variations. Regulation is achieved by the following steps:
1. Connect the source of a transistor to the appropriate power supply; Vdd for PMOS or Vss for NMOS.
2. Force a current from drain to source of the transistor approximately equal to the current the transistor conducts at Vds=Vgs=Vt.
3. Vary the body bias such that the drain voltage substantially equals the gate voltage.
4. Supply the body bias to similar transistors on the chip for which speed or leakage control is desired.

In accordance with a particular implementation of the technique of the present invention disclosed herein, the Vₜ of certain transistors is lowered at low power supply voltage (VCC) levels, low temperature and/or high Vₜ process conditions to assure adequate transistor drive but may also be raised at high VCC levels, high temperature and/or low Vₜ process conditions to reduce leakage current. In the representative embodiment disclosed herein, the gate of an N-channel transistor may be connected to VCC/2, the source to VSS and the drain to VCC via a resistor. The voltage on the body of the transistor is then varied to achieve a drain voltage of VCC/2. The same voltage is then supplied to all similar transistors on the chip for which speed control or “off” current control is desired. Changing body bias of the transistor (also called the back gate bias) causes the Vₜ of the transistor to change. In this manner, circuit speed that is closer to constant (versus VCC, temperature and process variation) is thereby achieved.

In accordance with the technique of the present invention, the body bias of P-channel transistors may be controlled in an analogous manner. In addition, the VCC/2 level utilized in the representative embodiment of the present invention disclosed herein could actually be any function of VCC while the resistor employed could, alternatively, be replaced by a current source.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a representative NMOS version of an integrated circuit transistor body bias regulation circuit in accordance with the present invention; and

FIG. 2 is a corresponding functional block diagram of a representative PMOS version of an integrated circuit transistor body bias regulation circuit in accordance with the present invention.

### DESCRIPTION OF A REPRESENTATIVE EMBODIMENT

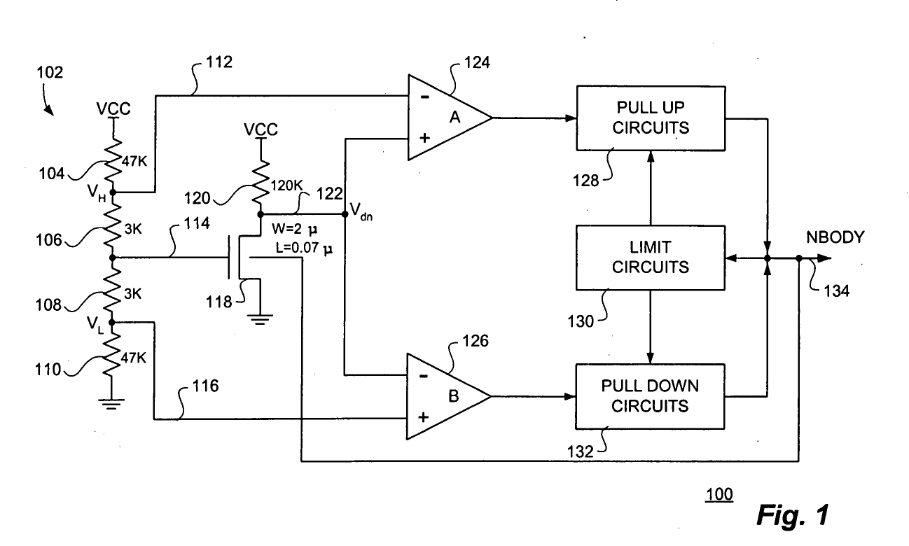

With reference now to FIG. 1, a functional block diagram of a representative NMOS version of an integrated circuit transistor body bias regulation circuit 100 in accordance with the present invention is shown. The transistor body bias regulation circuit (or regulator) 100 comprises, in pertinent part, a voltage divider 102 comprising series connected resistors 104, 106, 108 and 110 coupled between a supply voltage source (VCC) and a reference voltage (VSS, or circuit ground). In the particular embodiment illustrated, resistors 104 and 110 may have a value of substantially 47 Kohms while resistors 106 and 108 may have a value of substantially 3 Kohms. The node 112 intermediate resistors 104 and 106 defines V_{H}, the node 114 between resistors 106 and 108 defines VCC/2 and the node 116 intermediate resistors 108 and 110 defines V_{L}. V_{H} and V_{L} are to provide a dead band between pull up and pull down current generation. Alternatively, a dead band could be provided by differential amplifier 124 and 126 design.

Node 114 is coupled to the gate terminal of an N-channel reference device (e.g. a transistor) 118 which has its source terminal coupled to circuit ground and its drain terminal coupled to VCC through a current limiting resistor 120 which, in the embodiment illustrated, may have a value of substantially 120 Kohms. The transistor 118 may have, for example a channel width of approximately 2.0 μ and a length of about 0.07 μ.

The drain terminal of transistor 118 defines a voltage Vdn (n-channel drain voltage) on line 122 which is furnished to the “+” input of a differential amplifier 124 (differential amplifier “A”) and the “−” input of another differential amplifier 126 (differential amplifier “B”). The “−” input of differential amplifier 124 is coupled to node 112 while the “+” input of differential amplifier 126 is coupled to node 116. The output of differential amplifier 124 is provided to control a pull up circuits block 128 and the output of differential amplifier 126 is provided to a corresponding pull down circuits block 132. A limit circuits block 130 is coupled to both the pull up circuits block 128 and pull down circuits block 132 to control the maximum amount of pull up and pull down voltage generated at their outputs coupled to provide an NBODY voltage at line 134 which is also coupled to the body (or back gate) of transistor 118.

The circuit 100 illustrated represents, in general, an NMOS implementation of the present invention. The reference transistor 118 may be processed in the same manner and have the same channel length as other NMOS transistors in the IC for which the body bias, NBODY, is to be controlled. In operation, the gate voltage is set at VCC/2 by the resistor voltage divider 102, although other methods of generating a voltage that is a function of VCC (inclusive of those providing a voltage other than VCC/2) could also be used.

The differential amplifier 124 signals the pull up circuits 128 to increase the NBODY voltage if the drain voltage (Vdn) is above V_{H}. On the other hand, differential amplifier 126 signals the pull down circuits 132 to decrease the NBODY voltage if Vdn is below V_{L}. The limit circuits block 130 functions to prevent excessive forward or reverse bias. Excessive forward bias would result in high body-to-source current while excessive reverse bias could cause excessive drain-to-body voltage.

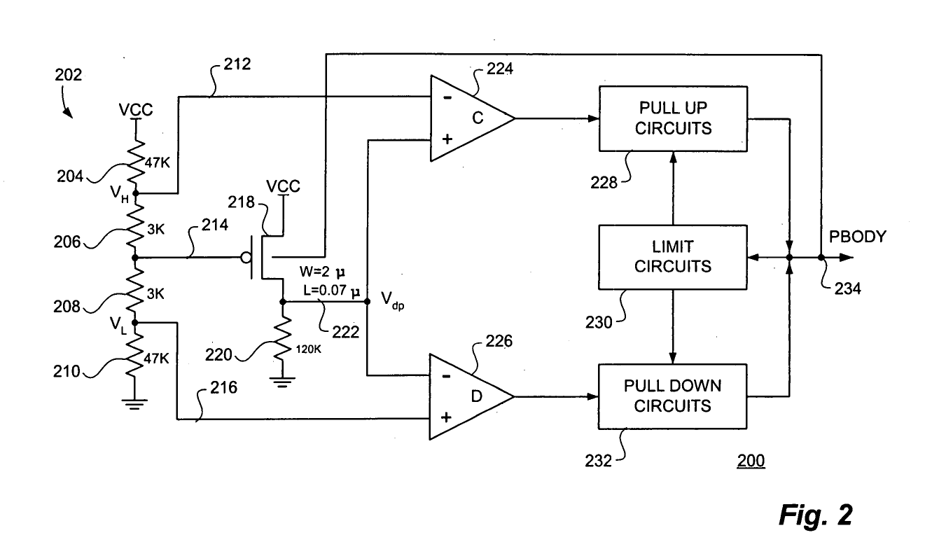

With reference additionally now to FIG. 2, a corresponding functional block diagram of a representative PMOS version of an integrated circuit transistor body bias regulation circuit 200 in accordance with the present invention is shown. The transistor body bias regulation circuit 200 comprises, in pertinent part, a similar voltage divider 202 comprising series connected resistors 204, 206, 208 and 210 coupled between VCC and circuit ground. In the particular embodiment illustrated, resistors 204 and 210 may again have a value of substantially 47 Kohms while resistors 206 and 208 may have a value of substantially 3 Kohms. The node 212 intermediate resistors 204 and 206 similarly defines V_{H}, the node 214 between resistors 206 and 208 defines VCC/2 and the node 216 intermediate resistors 208 and 210 defines V_{L}. V_{H} and V_{L} are to provide a dead band between pull up and pull down current generation. Alternatively, a dead band could be provided by differential amplifier 224 and 226 design.

Node 214 is coupled to the gate terminal of a P-channel reference transistor 218 which its source terminal coupled to VCC and further has its drain terminal coupled to circuit ground through a current limiting resistor 220 which, in the embodiment illustrated, may also have a value of substantially 120 Kohms. The transistor 218 may have, for example a channel width of approximately 2.0 μ and a length of about 0.07 μ.

The drain terminal of transistor 218 defines a voltage Vdp (p-channel drain voltage) on line 222 which is furnished to the “+” input of a differential amplifier 224 (differential amplifier “C”) and the “−” input of another differential amplifier 226 (differential amplifier “D”). The “−” input of differential amplifier 224 is coupled to node 212 while the “+” input of differential amplifier 226 is coupled to node 216. The output of differential amplifier 224 is provided to control a pull up circuits block 228 and the output of differential amplifier 226 is provided to a corresponding pull down circuits block 232. A limit circuits block 230 is coupled to both the pull up circuits block 228 and pull down circuits block 232 to control the maximum amount of pull up and pull down voltage generated at their outputs coupled to provide a PBODY voltage at line 234 which is also coupled to the body of transistor 218.

The circuit 200 illustrated represents, in general, a PMOS implementation of the present invention. Again, the reference transistor 218 may be processed in the same manner as other PMOS transistors in the IC for which the body bias, PBODY, is to be controlled. The gate voltage may also be set at VCC/2 by the resistor voltage divider 202, although other methods of generating a voltage that is a function of VCC (inclusive of those providing a voltage level of other than VCC/2) could also be used.

Differential amplifier 224 functions to signal the pull up circuits 228 to increase the PBODY voltage if Vdp (drain voltage) is above V_{H}. Further, differential amplifier 226 signals the pull down circuits 232 to decrease the PBODY voltage if Vdp is below V_{L}. The limit circuits block 230 prevents excessive forward or reverse bias. Excessive forward bias would result in high body-to-source current while excessive reverse bias could cause excessive drain-to-body voltage.

While there have been described above the principles of the present invention in conjunction with specific circuit implementations and devices, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

1. An integrated circuit device for controlling the threshold voltage of a transistor to be a function of a supply voltage by applying a body bias voltage to said transistor comprising:
a first voltage reference which is a function of said supply voltage;
an n-channel transistor with a gate coupled to said first voltage reference and a source coupled to system ground;
means for supplying a current to a drain of said transistor; and
means for controlling said body bias voltage of said transistor to cause a drain voltage of said transistor to be substantially equal to said first voltage reference.

2. The integrated circuit device of claim 1 wherein said first reference voltage is determined by a resistor divider network.

3. The integrated circuit device of claim 1 wherein said means for supplying a current to a drain of said transistor comprises a resistor coupled from said drain of said transistor to said supply voltage.

4. The integrated circuit device of claim 1 wherein said means for supplying a current to a drain of said transistor comprises a current source coupled from said drain of said transistor to said supply voltage.

5. The integrated circuit device of claim 1 wherein said first voltage reference is substantially one half of a level of said supply voltage source.

6. The integrated circuit device of claim 1 wherein said body bias voltage is additionally supplied to one or more additional similar n-channel transistors.

7. The integrated circuit device of claim 1 further comprising:
means for limiting said body bias voltage.

8. An integrated circuit device for controlling the threshold voltage of a transistor to be a function of a supply voltage by applying a body bias voltage to said transistor comprising:
a first voltage reference which is a function of said supply voltage;
a p-channel transistor with a gate coupled to said first voltage reference and a source coupled to said supply voltage;
means for supplying a current to a drain of said transistor; and
means for controlling said body bias voltage of said transistor to cause a drain voltage of said transistor to be substantially equal to said first voltage reference.

9. The integrated circuit device of claim 8 wherein said first reference voltage is determined by a resistor divider network.

10. The integrated circuit device of claim 8 wherein said means for supplying a current to a drain of said transistor comprises a resistor coupled from said drain of said transistor to system ground.

11. The integrated circuit device of claim 8 wherein said means for supplying a current to a drain of said transistor comprises a current source coupled from said drain of said transistor to said system ground.

12. The integrated circuit device of claim 8 wherein said first voltage reference is substantially one half of a level of said supply voltage source.

13. The integrated circuit device of claim 8 wherein said body bias voltage is additionally supplied to one or more additional similar p-channel transistors.

14. The integrated circuit device of claim 8 further comprising:
means for limiting said body bias voltage.

15. A method for controlling the threshold voltage of an n-channel transistor to be a function of a supply voltage by applying a body bias voltage to said transistor comprising:
providing a first voltage reference which is a function of said supply voltage;
applying said first voltage reference to a gate of said n-channel transistor;
coupling a source of said n-channel transistor to system ground;
supplying a current to a drain of said transistor; and
adjusting said body bias voltage of said transistor such that a drain voltage of said transistor is made substantially equal to said first voltage reference.

16. The method of claim 15 wherein said body bias voltage is further applied to additional transistors.

17. A method for controlling the threshold voltage of an p-channel transistor to be a function of a supply voltage by applying a body bias voltage to said p-channel transistor comprising:
providing a first voltage reference which is a function of said supply voltage;
applying said first voltage reference to a gate of said n-channel transistor;
coupling a source of said p-channel transistor to said supply voltage;
supplying a current to a drain of said transistor; and
adjusting said body bias voltage of said transistor such that a drain voltage of said transistor is made substantially equal to said first voltage reference.

18. The method of claim 17 wherein said body bias voltage is further applied to additional transistors.

19. A method for controlling the threshold voltage of a plurality of transistors on a common substrate comprising:
establishing a first voltage level which is a function of a supply voltage level;
applying said first voltage level to a gate of a reference transistor;
adjusting a threshold voltage of said reference transistor such that said threshold voltage of said reference transistor is substantially equal to said first voltage level; and
similarly adjusting a threshold voltage of others of said plurality of transistors in accordance with said step of adjusting said threshold voltage of said reference transistor.
